(19) United States
(12) Patent Application Publication
(10) Pub. No.: US 2017/0158568 A1
(43) Pub. Date: Jun. 8, 2017

(54) ULTRA-LIGHT MINERAL FOAM AND METHOD FOR PRODUCING SAME

(71) Applicant: LAFARGE, Paris (FR)

(72) Inventors: Hélène LOMBOIS-BURGER, SAINT QUENTIN FALLAVIER (FR); Christian BLACHIER, SAINT QUENTIN FALLAVIER (FR); Sylvain DUCHAND, SAINT QUENTIN FALLAVIER (FR); Cédric ROY, SAINT QUENTIN FALLAVIER (FR)

(21) Appl. No.: 15/316,433

(22) PCT Filed: Jun. 4, 2015
(86) PCT No.: PCT/FR2015/051477

§ 371 Date: Dec. 6, 2016

(30) Foreign Application Priority Data
Jun. 6, 2014 (FR) 1455172

(51) Int. Cl. C04B 38/10; C04B 28/14; C04B 28/04

(52) U.S. Cl. CPC C04B 38/106; C04B 28/04; C04B 28/14

(57) ABSTRACT

A method for producing a mineral foam includes: (i) independently preparing a cement slurry and an aqueous foam, the cement slurry being prepared by mixing water E and cement C, the cement C including a soluble equivalent quantity x of Na₂O, x being expressed by weight for 100 parts cement, the slurry having a ratio x/(E/C) less than or equal to 1.75, E/C being expressed by weight, and the particles of cement C having a size distribution such that the particle size distribution ratio d_{max(h/2)}/d_{min(h/2)} is between 5 and 25; (ii) bringing the cement slurry into contact with the aqueous foam in order to obtain a foamed cement slurry; and (iii) shaping the foamed cement slurry obtained in step (ii) and allowing setting to take place.

The present invention relates to an ultra—light cement—based mineral foam, to a method for producing this foam and to construction elements comprising this foam.

In general, a mineral foam, in particular a cement foam, is highly advantageous for numerous applications on account of its properties such as thermal and sound insulation, durability, fire resistance and ease of use.

Mineral foam designates a material in the form of a foam. This material is lighter than traditional concrete on account of the pores or voids contained therein. These pores or voids are due to the presence of air in the mineral foam and may be in the form of bubbles. By ultra—light foam is meant foam having a dry density generally of 30 to 300 kg/m³.

When an element in mineral foam is cast it may collapse, for example through lack of stability of the mineral foam as soon as it is placed or before complete hardening. These problems of foam collapse may be due to phenomena of coalescence, Ostwald ripening, hydrostatic pressure or drainage, the latter particularly being more extensive in elements of large height.

The difficulty in producing mineral foam is therefore the obtaining of a stable foam overcoming problems of collapse. Yet known techniques to allow the obtaining of sufficiently stable foam have recourse to mixtures of cementitious compounds comprising numerous admixtures which are therefore difficult and costly to produce.

The simultaneous use has already been proposed in U.S. Pat. No. 5,696,174 of cationic (I) and anionic (II) compounds to produce foams. Such cement foams comprise ammonium stearate as anionic compound and a cationic compound called Arquad T.

Application WO 2013/150148 describes cement—based foams comprising various admixtures. These foams may comprise calcium aluminate to allow rapid setting, or fine mineral particles.

To meet user requirements, it has become necessary to find means for producing an ultra-light mineral foam, having high stability and which is relatively easy to produce at low cost.

Therefore, the problem that the invention sets out to solve is to find a formulation for a stable, ultra-light mineral foam which does not collapse when the foam is vertically cast and is relatively easy and cheap to process.

The invention relates to a method for producing a mineral foam comprising the following steps:
(i) independently preparing a cement slurry and an aqueous foam, the cement slurry being prepared by mixing water W and cement C, the cement C comprising an amount x of soluble Na₂O equivalent, x being expressed in weight per 100 parts of cement, said slurry having a ratio x/(W/C) less than or equal to 1.75, with W/C expressed by weight, and the particles of cement C have a particle size distribution such that the ratio d_{max(h/2)}/d_{min(h/2)} of the particle size distribution is between 5 and 25;
(ii) contacting the cement slurry with the aqueous foam to obtain a slurry of foamed cement; and
(iii) forming the slurry of foamed cement obtained at step (ii) and leaving to set.

The soluble Na₂O equivalent amount, or alkali content, of the cement slurry is therefore surprisingly an important characteristic in the production of a stable mineral foam. Here the expression “alkali content” is used to designate the weight proportion of soluble Na₂O equivalent i.e. of soluble sodium or potassium ions ((M_{Na2O}/M_{K2O})*K₂O+Na₂O)=Na₂O_{eq} in the cement used to implement the method of the invention, with M being the molar mass of the compounds in subscript. The K₂O and Na₂O levels are measured after dissolution by atomic emission spectrometry, a method known as ICP-AES described below.

This cement C is placed in the presence of a given amount of water W in the slurry, characterized by the weight ratio W/C. The limit value in terms of alkali to allow stability of the final mineral foam is characterized by the ratio x/(W/C) which must not exceed 1.75, x being the amount of soluble Na₂O equivalent (Na₂O eq) by weight per 100 parts of cement.

Advantageously, the weight ratio x/(W/C) is less than or equal to 1.60, preferably less than or equal to 1.50.

Preferably, the weight ratio x/(W/C) is between 0.1 and 1.75.

To implement the invention and achieve the weight ratio x/(W/C), one of the elements to be taken into consideration is therefore the alkali content of the cement. The selecting of a cement already having a low alkali content when produced (e.g. a low alkali cement of CEM I type or use of a compound cement) is one simple way to reach this ratio and to obtain an ultra—light foam. However, there are other ways to achieve the target ratio e.g. diluting the cement through the addition of water.

The cement used in the method of the invention comprises particles having a distribution size such that the ratio d_{max(h/2)}/d_{min(h/2)} of particle size distribution (volume distribution) is from 5 to 25, preferably this ratio d_{max(h/2)}/d_{min(h/2)} is from 6 to 14.

The particle size distribution in a sample is measured using the laser diffraction method. Said particle size distribution may be that of a monodisperse population of solid particles. By monodisperse is meant that the graphical representation of particle size distribution (volume abundance as a function of size graduated on a Renard series scale) only has one peak (a single population). This definition of “monodisperse load” preferably excludes particle stacking of several populations of different particle sizes.

A group of particles of different sizes can be characterized in particular by the ratio between (i) the size of the largest particles at mid-height (d_{max(h/2)}) and (ii) the size of the finest particles at mid-height (d_{min(h/2)}. To implement the invention this ratio is in the order of 5 to 25 in the cement used, preferably from 6 to 14.

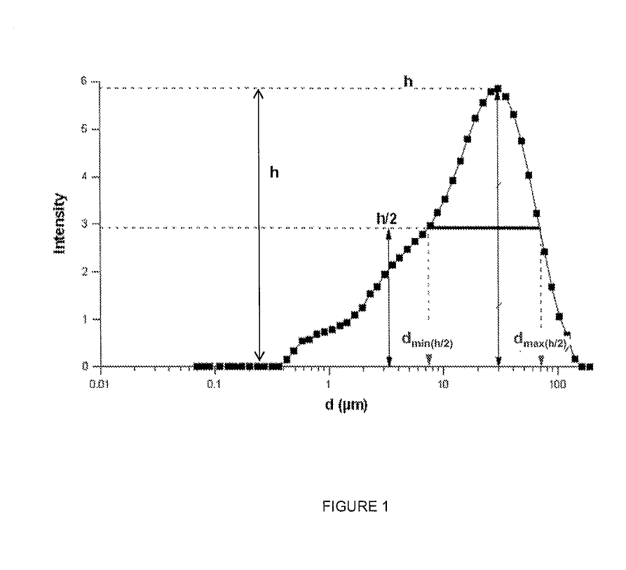

The values d_{max(h/2)} and d_{min(h/2)} are obtained as follows: the height h is the height of the highest peak measured by laser particle size measurement represented in volume (see for example FIG. 1). Taking height h/2 as reference, d_{max(h/2)} and d_{min(h/2)} are respectively defined as the largest particle size and smallest particle size having a proportion equal to h/2.

Preferably, the cement used in the method of the invention comprises particles having a monodisperse particle size distribution.

Cement is a hydraulic binder comprising a proportion at least equal to 50% by weight of calcium oxide (CaO) and silicon dioxide (SiO₂). A cement may therefore comprise other compounds in addition to CaO and SiO₂, and in particular Portland clinker, slag, silica fume, pozzolan (natural and calcined natural), fly ash (siliceous and calcic), shale and/or limestone. The cements able to be used in the method of the invention for the production of mineral foam can be selected from among the cements described in standard NF-EN197-1 of April 2012, in particular the cements CEM I, CEM II, CEM III, CEM IV or CEM V.

The cement used to carry out the invention is preferably selected from among commercially available cements having sufficiently low alkalinity or “low alkali cements”. Low alkali cements of Portland type are the preferred cements. However, if Portland cements and in particular their clinker content have an alkali proportion that is too high, such cements can be diluted through the addition of compounds such as limestone CaCO₃, slag, fly ash, pozzolan or the mixtures thereof. In this case, cements composed of CEM II to V types comprising a non-negligible proportion of components other than clinker can be used to reduce alkalinity and to reach the desired concentration.

According to one particular embodiment, the cement suitable for use in the present invention has a Blaine specific surface area of 3 500 to 10 000 cm²/g, preferably 6 000 to 9 000 cm²/g.

The Portland cement able to be used in the present invention can be milled and/or separated (using a dynamic separator) to obtain cement having a Blaine specific surface area of 5 500 cm²/g or higher. This cement can be qualified as being ultra-fine. The cement can be milled using 2 methods.

According to a first method, the cement or clinker can be milled to a Blaine specific surface area of 5 500 to 10 000 cm²/g. A second or third generation high efficiency separator or very high efficiency separator can be used at this first step to separate the cement having the desired fineness. The material not having the desired fineness is returned to the mill.

The mills that can be used for this method are ball mills for example or a vertical mill, roller press, horizontal mill (e.g. of Horomill© type), an agitated vertical mill (e.g. Tower Mill type), an agitated bead mill or any other type of mill adapted for the fine milling of mineral particles.

According to a second method, a Portland cement can be passed through a dynamic separator to extract the finest particles, so as to reach the target fineness (higher than 5 500 cm²/g). The fine material can be used as such. The coarse material is removed for other applications or returned towards a different milling circuit.

The cement slurry used in the method of the invention may advantageously comprise a water reducing agent of plasticizer or superplasticizer type. A water reducing agent allows a reduction in mixing water of about 10 to 15 weight % over a given workability time. As examples of water reducing agents mention can be made of lignosulphonates, hydroxycarboxylic acids, carbohydrates and other specific organic compounds such as glycerol, polyvinyl alcohol, sodium aluminomethyl siliconate, sulfanilic acid and casein (see Concrete Admixtures Handbook, Properties Science and Technology, V. S. Ramachandran, Noyes Publications, 1984). Superplasticizers belong to the new generation of water reducing agents and allow a reduction in mixing water of about 30 weight % for a given workability time. As examples of superplasticizers mention can be made of PCP superplasticizers free of anti-foaming agent, PEO diphosphonates, PEO polyphosphates. By the term “PCP” or “polycarboxylate polyoxide” according to the invention is meant a copolymer of acrylic or methacrylic acids and their polyethylene oxide esters (PEO).

Preferably, the cement slurry used to produce the mineral foam of the invention comprises 0.05 to 1%, more preferably 0.05 to 0.5% of water reducing agent, a plasticizer or superplasticizer, percentage expressed in dry weight relative to the weight of the cement slurry.

Preferably, the water reducing agent of plasticizer or superplasticizer type does not contain any anti-foaming agent.

The cement slurry or aqueous foam may also comprise 0.05 to 2.5% of an accelerator, percentage expressed in dry weight relative to the cement. This accelerator may derive from one or more salts selected from among:
calcium salts, potassium salts and sodium salts, in which the anion may be a nitrate, nitrite, chloride, formiate, the thiocyanate, sulfate, bromide, carbonate or mixtures thereof; and
alkaline silicates and aluminates, e.g. sodium silicate, potassium silicate, sodium aluminate, potassium aluminate or mixtures thereof; aluminium salts e.g. aluminium sulfate, aluminium nitrate, aluminium chloride, aluminium hydroxide or mixtures thereof.

According to one particular embodiment, the aqueous foam does not comprise an accelerator and in particular no calcium salts.

Other admixtures can be added either to the cement slurry or to the aqueous foam. Said admixtures may be a thickening agent, viscosifying agent, air entraining agent, set retarder, clay inerting agent, pigments, colouring agents, hollow glass beads, film-forming agents, hydrophobic agents or depollutants (e.g. zeolites or titanium dioxide), latex, organic or mineral fibres, mineral additions or mixtures thereof.

Preferably the admixtures used do not comprise any anti-foaming agent.

Preferably the mineral foam of the invention comprises a mineral addition. This addition may be added to the cement slurry during the method of the invention.

For example, the mineral additions are slag (e.g. such as defined in standard NF EN 197-1 of April 2012, paragraph 5.2.2), pozzolan (e.g. such as defined in standard NF EN 197-1 of April 2012, paragraph 5.2.3), fly ash (e.g. such as defined in standard NF EN 197-1 of April 2012, paragraph 5.2.4), calcined shale (e.g. such as defined in standard NF EN 197-1 of April 2012, paragraph 5.2.5), materials containing calcium carbonate such as limestone (e.g. such as defined in standard NF EN 197-1 of April 2012, paragraph 5.2.6), silica fume (e.g. such as defined in standard NF EN 197-1 of April 2012, paragraph 5.2.7), metakaolins or mixtures thereof.

However, according to one particularly preferred aspect of the invention, only a limited number of components is used. Therefore, the mineral foam may only be formed either of cement, water and a foaming agent, or of cement, water, a foaming agent and a water reducing agent of plasticizer or superplasticizer type such as a PCP.

Such a formulation allows considerable savings in time and cost and goes against preconceived technical opinion according to which the use of various admixtures is necessary to ensure the stability of a cement foam.

Preferably, the mineral foam of the invention contains substantially no fine particles. By the expression “fine particles” is meant a population of particles having a median diameter D50 strictly lower than 2 μm. D50, also denoted D_{V}50, corresponds to the 50^{th} percentile of particle size distribution in volume i.e. 50% of the volume is formed of particles having a size smaller than D50 and 50% of size larger than D50.

By the term “substantially” is meant less than 1%, advantageously less than 5%, expressed in weight relative to the weight of the cement.

According to another aspect of the invention, the mineral foam of the invention does not contain a mixture of two organic compounds respectively forming a long chain anionic compound and cationic compound such as described in U.S. Pat. No. 5,696,174.

The cements that are little or not suitable for implementation of the invention are calcium aluminate cements and mixtures thereof. Calcium aluminate cements are cements generally comprising a mineralogical phase, C4A3$, CA, C12A7, C3A or C11A7CaF2 or mixtures thereof such as Ciments Fondue, sulfoaluminate cements, calcium aluminate cements conforming to European standard NF EN 14647 of December 2006. Such cements are characterized by an aluminium oxide content (Al2O3) greater than or equal to 35 weight. Therefore, to carry out the method of the invention, the aluminium oxide content of the dry mineral compound used to produce the foam is less than 35 weight % of the dry mineral compound. Preferably this content is less than or equal to 30%, advantageously less than or equal to 20%, more advantageously less than or equal to 15%, and further advantageously less than or equal to 10%, in dry compound weight.

According to a first embodiment, the cement slurry can be prepared by loading the cement mixer with the cement and optionally all the other materials in powder form. The cement is mixed to obtain a homogeneous mixture. Water is then added to the mixer. The admixture(s) such as a water reducing agent are added with the water if they are contained in the formulation of the mineral foam. The paste obtained is mixed to obtain a cement slurry.

Preferably, the cement slurry is held under agitation e.g. using a deflocculating blade, the speed of the blade possibly varying from 1000 rpm to 400 rpm, as a function of slurry volume, throughout the entire duration of the method to produce the mineral foam of the invention.

According to a second embodiment, the cement slurry can be prepared by loading part of the water in the mixer, followed by the cement and then the other compounds.

According to a third embodiment, the cement slurry can be continuously generated.

To prepare the cement slurry, the W/C ratio of this slurry may advantageously range from 0.23 to 2.0, preferably from 0.25 to 0.60, for example equal to 0.29, the ratio being expressed by weight.

The aqueous foam can be prepared by contacting the water with a foaming agent and then adding a gas. Therefore, the aqueous foam comprises water and a foaming agent. This gas is preferably air. The amount of foaming agent is generally between 0.25 and 5% by dry matter weight of foaming agent relative to the weight of water, preferably 0.75% to 2.5%. The adding of air can be obtained by agitation, bubbling or injection under pressure. Preferably, the aqueous foam can be prepared using a turbulence foamer (bed of glass beads for example). This type of foamer allows air to be added under pressure to an aqueous solution comprising a foaming agent.

Preferably, the aqueous foam can be generated continuously.

The generated aqueous foam has an air bubble size having a D50 equal to or less than 400 μm, preferably from 100 to 400 μm, more preferably from 150 to 300 μm. D50, also denoted D_{V}50, corresponds to the 50^{th} percentile of particle size distribution in volume i.e. 50% of the volume is formed of particles having a size smaller than D50 and 50% of size larger than D50.

Preferably, the generated aqueous foam has an air bubble size having a D50 of 250 μm.

The D50 of the bubbles is measured by back scattering. The apparatus used is Turbiscan® Online supplied by Formulaction. Back scattering measurements allow an estimation of the D50 for bubbles of an aqueous foam with knowledge of the volume fraction of the bubbles and the refractive index of the foaming agent solution.

Preferably, the foaming agent is an organic derivative of proteins of animal origin (e.g. the foaming agent Propump26, a powder of hydrolysed keratin sold by Propump) or plant origin. The foaming agents may also be cationic (e.g. cetyltrimethylammonium CTAB), anionic, amphoteric (e.g. cocoamidopropyl betaine CAPB) or non-ionic surfactants, or mixtures thereof.

The contacting of the cement slurry with the aqueous foam to obtain a slurry of foamed cement can be performed using any means e.g. using a static mixer.

According to one more particular embodiment, the cement slurry is pumped at a constant volume rate as a function of the composition of the target foamed cement slurry.

The cement slurry is then contacted with the aqueous foam already in circulation in the circuit of the process. The foamed cement slurry of the invention is thus generated. This foamed cement slurry is formed and left to set.

Advantageously, the method of the invention does not require an autoclave step or curing step or heat treatment step e.g. at 60-80° C. to obtain a cement foam of the invention.

The mineral foam of the invention can be pre-manufactured or directly prepared at the worksite by installing an onsite foaming system.

A further subject of the invention is a foamed cement slurry which can be obtained at step (ii) of the method of the invention.

A further subject of the invention is a mineral foam obtainable using the method of the invention.

Preferably, the mineral foam of the invention has a dry density of 35 to 300 kg/m³, more preferably of 50 to 150 kg/m³, further preferably of 50 to 80 kg/m³. It is to be noted that the density of the foamed cement slurry (wet density) differs from the density of the mineral foam (density of hardened material).

Preferably, the mineral foam of the invention has thermal conductivity of 0.030 to 0.150 W/(m·K), more preferably 0.030 to 0.060 W/(m·K) and further preferably 0.030 to 0.040 W/(m·K), the margin of error being ±0.4 mW/(m·K).

The invention also relates to a construction element comprising a mineral foam of the invention.

The use of the mineral foam of the invention in the construction sector is also a subject of the invention. For example, the mineral foam of the invention can be used to cast walls, floors, roofing on a worksite. It is also envisaged to produce prefabricated elements from the foam of the invention at a prefabrication plant, such as blocks, panels.

The invention also relates to the use of the mineral foam of the invention as insulating material, in particular as thermal or sound insulation.

Advantageously, the mineral foam of the invention in some cases allows the replacement of glass wool, mineral wool or polystyrene or polyurethane insulating materials.

Preferably, the mineral foam of the invention therefore has very low thermal conductivity. Reducing the thermal conductivity of building materials is highly desirable since it brings savings in heating energy in homes and at workplaces. In addition, the mineral foam of the invention allows good insulating performance to be obtained with narrow thicknesses, thereby preserving habitable surfaces and volumes. Thermal conductivity (also known as lambda (A)) is a physical magnitude characterizing the behaviour of materials at the time of heat transfer via conduction. Thermal conductivity represents the amount of heat transferred per unit surface area and per unit of time under a temperature gradient. In the international unit system, thermal conductivity is expressed in watts per metre-kelvin (W·m−1·K−1). Conventional or traditional concretes have thermal conductivity between 1.3 and 2.1 measured at 23° C. and 50% relative humidity. The mineral foam of the invention can be selected from among foams having thermal conductivity ranging from 0.030 to 0.150 W/(m·K), preferably 0.030 to 0.060 W/(m·K) and more preferably 0.030 to 0.040 W/(m·K), the margin of error being ±0.4 mW/(m·K).

Advantageously, the mineral foam of the invention can be used for filling an empty space or hollow in a building, a wall, partition, masonry block e.g. a breeze block, a brick, floor or ceiling. Said materials or composite building elements comprising the mineral foam of the invention are also subjects of the invention per se.

Advantageously, the mineral foam of the invention can be used as facade rendering e.g. for the external insulation of a building. In this case, the mineral foam of the invention may be coated with a finish rendering.

A further subject of the invention is a device comprising the mineral foam of the invention. The foam may be contained in the device as insulating material. The device of the invention is advantageously capable of resisting or reducing air and thermo-hydric transfer i.e. this element has controlled permeability against transfer of air and of water in vapour or liquid form.

The device of the invention preferably comprises at least one frame or structural element. This frame may be in concrete (posts/beams), metal (upright or rail), wood, plastic, composite material or synthetic material. The mineral foam of the invention may also surround a structure of lattice type for example (plastic, metallic).

The device of the invention can be used to form or manufacture a lining, insulating system, or partition e.g. a dividing partition, load distributing partition or wall lining.

The mineral foam of the invention can be vertically cast between two walls selected for example from among concrete shells, brick walls, plasterboards, wood board e.g. oriented thin strip wood panels, or fibre-cement panels, the whole forming a device.

The invention will be better understood on reading the following examples and Figures that are not in any manner restrictive and in which:

FIG. 1 is a graphical illustration of the particle size distribution in a typical cement used to implement the invention.

The following measuring methods were used:

Laser Particle Size Measurement

The particle size curves of the different powders were obtained using a laser size analyser of Mastersizer 2000 type (year 2008, series MAL1020429) sold by Malvern.

Measurement is carried out in a suitable medium (e.g. an aqueous medium) to disperse the particles; the particle size must be between 1 μm and 2 mm. The light source is a red He—Ne laser (632 nm) and blue diode (466 nm). The optical mode is a Fraunhofer model with polydisperse particle sizing standard.

Measurement of background noise is first performed using a pump rate of 2000 rpm, an agitator speed of 800 rpm and noise measurement over 10 s, in the absence of ultrasound. It is first verified that the light intensity of the laser is at least 80%, and that a decreasing exponential curve is obtained for background noise. If this is not the case, the cell lenses must be cleaned.

A first measurement is taken on the sample with the following parameters: pump speed 2000 rpm, agitator speed 800 rpm, no ultrasound, obscuration limit between 10 and 20%. The sample is inserted to obtain obscuration slightly higher than 10%. After stabilisation of obscuration, measurement is conducted with a time between immersion and measurement set at 10 s. Measurement time is 30 s (30000 diffraction images analysed). In the size distribution graph obtained, consideration must be given to the fact that part of the powder population may be agglomerated.

A second measurement is then carried out (without emptying the vessel) with ultrasound. The pump rate is increased to 2500 rpm agitation to 1000 rpm, and with 100% ultrasound emission (30 watts). This regimen is maintained for 3 minutes, before returning to the initial parameters: pump rate 2000 rpm, agitator speed 800 rpm, no ultrasound. After 10 s (to evacuate any air bubbles), a 30 s measurement is performed (30000 images analysed). This second measurement corresponds to a powder de-agglomerated by ultrasonic dispersion.

Each measurement is repeated at least twice to verify the stability of the result. The apparatus is calibrated before each work session using a standard sample (C10 silica Sifraco) having a known particle size curve. All the measurements given in the description and the given ranges correspond to the values obtained with ultrasound.

Method for Measuring BLAINE Specific Surface Area

The specific surface area of the different materials was measured as follows:

The Blaine method at 20° C. with relative humidity not exceeding 65%, using Blaine Euromatest Sintco apparatus conforming to European standard EN 196-6.

Before measuring the specific surface area, the wet samples were dried to constant weight in an oven at a temperature of 50 to 150° C. (the dried product was then ground to obtain a powder having a maximum particle size of 80 μm or less).

Method for Measuring Alkali Content:

The alkali contents (% K₂O and % Na₂O) of these cements were measured by atomic emission spectrometry, method known as ICP-AES (Inductively-Coupled Plasma-Atomic Emission Spectrometry). The model of the measuring apparatus was a Varian 720-ES, series EL06093608, 2006. To perform this measurement a sample of 2 g of cement was solubilised in 100 mL demineralised water for 15 minutes then filtered through two superimposed filter papers e.g. a first of MN640W type and a second of MN640DD type, in a 200 mL flask, then rinsed with demineralised water. 20 mL of hydrochloric acid were added at a concentration of 1/20 (volume/volume). The flask was completed up to the graduation line of 200 mL by adding demineralised water. This solution was analysed on the ICP-AES apparatus.

The content of soluble Na₂O equivalent was calculated on the basis of the following formula:

((M_{Na2O}/M_{K2O})*K₂O+Na₂O)=Na₂O_{eq}, M being the molar mass of the compounds in subscript.

### EXAMPLES OF EMBODIMENT

The method of the invention was practically applied to prepare cement foams of formulas I, II, V, VII, VIII, IX, X and XI. Comparative examples III, IV and VI were also carried out to evidence the advantageous aspects of the method of the invention.

Materials:

The cements used were Portland cements originating from different Lafarge cement plants identified by the name of the place of their location as specified in Table (I). These cements are standard type cements. The letters “R” and “N” correspond to the definition of standard NF EN 197-1, version April 2012.

Micro A anhydrite is anhydrous calcium sulfate supplied by Anhydrite Minerale France.

The superplasticizers used were mixtures comprising a polycarboxylate polyoxide (PCP) produced by Chryso under the name Chrysolab EPB530-017 (Formulas III to X) and Chrysolab EPB530-026 (Formulas I and II). They are based on Premia180 products (for Chrysolab EPB530-017) and Optima203 (for Chrysolab EPB530-026) and do not contain any anti-foaming agent. The dry extract of Chrysolab EPB530-017 is 48 weight %. The dry extract of Chrysolab EPB530-026 is 58 weight %.

The foaming agents used were derived from animal proteins and were the following:
Propump26 and Propump 40 produced by Propump, the dry extracts thereof being 26 and 34 weight % respectively;
MAPEAIR L/LA produced by MAPEÏ having a dry extract of 26 weight %;
Foamcem produced by LASTON having a dry extract of 28 weight %;
EFA 1500 produced by Edama, having a dry extract of 36 weight %.

The water used was tap water.

Equipment Used:

Rayneri Mixers:
Mixer of R 602 EV (2003) model supplied by Rayneri. The mixer is composed of a chassis on which drums of 10 to 60 litres are positioned. The 10 L drum was used with a paddle of blade type adapted to the volume of the drum. This paddle rotates about itself accompanied by planetary movement around the drum shaft.
Turbotest mixer (MEXP-101, model Turbotest 33/300, series N°: 123861) supplied by Rayneri. It is a mixer with vertical shaft.

Pumps:
Seepex™ eccentric screw pump of MD 006-24 type, commission N° 244920.
Seepex™ eccentric screw pump of MD 006-24 type commission N° 278702.

Foamer:
Foamer composed of a bed of glass beads of SB30 type having a diameter of between 0.8 and 1.4 mm, packed in a tube of length 100 mm and diameter 12 mm.

Static Mixer:
A static mixer composed of 32 helical elements of Kenics type, diameter 19 mm, reference 16La632 by ISOJET

In the following examples mineral foams were prepared. Each cement slurry is referenced with a number from I to XI and each aqueous foam carries a number from 1 to 6. The cement foam obtained (or mineral foam of the invention) is a combination of one of these cement slurries with one of these aqueous foams.

### I. Preparation of Mineral Foams

I.1 Preparation of a Cement Slurry

The chemical compositions of the different cement slurries used to carry out the invention are given in Table I. The slurries were prepared using the Rayneri R 602 EV mixer by previously loading the solid components (cement) then gradually adding water and the admixture. The slurry was then mixed for two additional minutes.

TABLE (I)
Formulation of the cement slurries

| | Formulas | | | | | | | | |
|---|---|---|---|---|---|---|---|---|---|
| | I | II | III | IV | V | VI | VII | VIII | IX |
| type of cement | CEM I | CEM I | CEM I | CEM I | CEM III/B | CEM I | CEM I | CEM I | CEM I |
| | 52.5 N | 52.5 R | 52.5 R | 52.5 R | 42.5 N | 52.5 R | 52.5 R | 52.5 R | 52.5 R |
| Lafarge plant | Le Havre | Le Tell | La Malle | Port La | La Malle | Saint | Saint | Saint | Val |
| | | | | Nouvelle | | Pierre | Pierre | Pierre | d'Azergue |
| | | | | | | La Cour | La Cour | La Cour | |
| x (% soluble Na2O-eq) | 0.22 | 0.14 | 0.78 | 0.54 | 0.43 | 0.66 | 0.66 | 0.66 | 0.4 |
| cement (weight %) | 78.80 | 77.54 | 77.30 | 77.44 | 77.99 | 76.87 | 68.87 | 66.56 | 66.18 |
| water (weight %) | 21.20 | 22.46 | 22.70 | 22.56 | 22.01 | 23.13 | 31.13 | 33.44 | 33.82 |
| Superplasticizer | 0.06 | 0.08 | 0.18 | 0.10 | 0.13 | 0.13 | 0.01 | 0.00 | 0.00 |
| (weight %) | | | | | | | | | |
| W/C ratio (weight) | 0.27 | 0.29 | 0.29 | 0.29 | 0.29 | 0.28 | 0.45 | 0.5 | 0.51 |
| x/(W/C) | 0.759 | 0.483 | 2.69 | 1.862 | 1.483 | 2.276 | 1.467 | 1.320 | 0.784 |
| d_{max(h/2)}/d_{min(h/2)} | 8.4 | 10.5 | 13.4 | 6.5 | 7.2 | 6.8 | 6.8 | 6.8 | 10.2 |

Formulas

| | X | XI |
|---|---|---|
| type of cement | CEM I 52.5 R (Blaine = 6340 cm2/g) | CEM I 52.5 R (Blaine = 9000 cm2/g) |
| Lafarge plant | Saint Pierre La Cour | Saint Pierre La Cour |
| Cement (weight %) | 16.33 | 16.15 |
| Addition (weight %) | 60.33 | 59.79 |
| Micro A anhydrite | 0.37 | 0.74 |
| (weight %) | | |
| Water (weight %) | 22.85 | 23.15 |
| SP superplasticizer | 0.12 | 0.18 |
| (weight %) | | |
| W/C ratio (weight) | 1.40 | 1.43 |
| W/L ratio (weight) | 0.30 | 0.30 |
| x (% soluble Na2O-eq) | 0.61 | 0.69 |
| x/(W/C) | 0.436 | 0.480 |
| d_{max(h/2)}/d_{min(h/2)} | 18.2 | 24.5 |

The values d_{max(h/2)} and d_{min(h/2)} were measured as described above, with reference to FIG. 1.

The results are generally visualised in graph form such as the graph given in FIG. 1 illustrating a typical particle distribution by volume. The height h is the height of the highest peak measured by laser particle size measurement (FIG. 1). Taking a height h/2 as reference, d_{max(h/2)} and d_{min(h/2)} are respectively defined as the size of the largest particles and the size of the smallest particles of distribution in a proportion equal to h/2.

I.2 Preparation of the Aqueous Foam

An aqueous solution containing the foaming agent was placed in a buffer vessel. The composition of his aqueous solution of foaming agent (in particular the concentration and type of foaming agent) is given in Table II. The solution of foaming agent was pumped through the volumetric eccentric screw pump Seepex™ MD 006-24 (commission N° 278702).

This solution of foaming agent was passed through the bed of beads of the foamer together with pressurised air (range 1 to 6 bars) using a T junction. The aqueous foam was continuously generated at the flow rate indicated in Table II.

TABLE II
formulation of aqueous foams and flow rate

| | Aqueous foam number | | | | | |
|---|---|---|---|---|---|---|
| | 1 | 2 | 3 | 4 | 5 | 6 |
| Foaming agent | Propump 26 | Propump 40 | MapeAIR L/LA | Foamcem | EFA1500 | Propump26 |
| Concentration | 4.5 | 3 | 2.5 | 3 | 1.5 | 3.5 |
| (% liq./water) | | | | | | |
| Concentration | 1.17 | 1.02 | 0.65 | 0.84 | 0.54 | 0.91 |
| (% dry/water) | | | | | | |
| Air flow rate | 8 | 8 | 8 | 8 | 8 | 8 |
| (L/min) | | | | | | |
| Solution flow rate | 0.41 | 0.418 | 0.41 | 0.41 | 0.418 | 0.418 |
| (L/min) | | | | | | |

I.3 Preparation of a Slurry of Foamed Cement:

The previously obtained cement slurry was poured into a buffer vessel held under agitation by means of a Turbotest Rayneri mixer (MEXP-101) comprising a deflocculating blade (blade adjustable from 1000 rpm to 400 rpm as a function of slurry volume). The slurry was pumped using a volumetric eccentric screw pump (Seepex™ MD 006-24, commission N°: 244920).

The pumped slurry and the preceding, continuously generated aqueous foam were placed in contact in the static mixer paying heed to the flow rates specified in Table II. The volume of cement slurry used was about 33 L/m3 and the volume of aqueous foam about 967 L/m3. The slurry of foamed cement was thus generated.

I.4 Obtaining a Mineral Foam

The slurry of foamed cement was cast into polystyrene cubes having sides of 10×10×10 cm and into cylindrical columns of height 2.50 m and diameter of 20 cm. Three cubes were prepared for each foamed slurry. The cubes were released from the could after 1 day and stored 7 days at 100% relative humidity and 20° C. The cubes were then dried to constant weight at 45° C. A column was formed with some of the foamed slurries. The columns were released from the mould between 3 and 7 days later and cut into sections of length 25 cm. The sections were dried at 45° C. to constant weight.

### II. Analysis of the Mineral Foam

### II.1 Stability of the Mineral Foam

The stability of the foams was simply measured by visual inspection of the generated cubes before mould release. A foam was described as being “stable” if the cube under consideration had maintained a height of 10 cm after setting. A foam was characterized as being “unstable” if the cube under consideration had collapsed when setting. Each test was performed on 3 cubes of 10*10*10 cm. The results show similar behaviour between the 3 cubes. When applicable, the results expressed are the mean of these 3 cubes.

A column was considered stable if the difference in density between the bottom section and the top section of the column did not exceed 5 kg/m³.

### II.2 Thermal Conductivity of the Mineral Foams

Thermal conductivity was measured using thermal conductivity measuring apparatus: TC-meter supplied by Alphis-ERE (Resistance 5Ω, wire probe 50 mm). Measurement was performed on samples dried at 45° C. to constant weight. The sample was then sawn into two pieces of equal size. The measuring probe was placed between the two planar surfaces of these two sample halves (sawn sides). Heat was transmitted from the source to the thermocouple through the material surrounding the probe. The temperature rise of the thermocouple was measured as a function of time and allowed calculation of the thermal conductivity of the sample.

### II.3 Density of the Mineral Foams

The wet density of the slurries of foamed cement was measured by weighing the cubes at the time of casting.

The dry density of the samples was measured on the dry samples dried at 45° C. to constant weight, again by weighing of the cubes.

### II.4 Results

The results are given in Tables III and IV below,

TABLE (III)
Analyses of mineral foams with the Propump26 foaming agent

| | Aqueous foam formula | | | | | | | | | | |
|---|---|---|---|---|---|---|---|---|---|---|---|
| | 1 | 1 | 1 | 1 | 1 | 1 | 1 | 1 | 1 | 1 | 1 |
| Slurry formula | I | II | III | IV | V | VI | VII | VIII | IX | X | XI |
| Wet density of foamed | 108 | 113 | 112 | 117 | 114 | 112 | 110 | 113 | 112 | 100 | 102 |
| slurry (g/l) | | | | | | | | | | | |
| Dry density (g/l) | 72 | 71 | — | — | 76 | — | 82 | 71 | 69 | 57 | 59 |
| Stability (cube) | Stable | Stable | Not | Not | Stable | Not | Stable | Stable | Stable | Stable | Stable |
| | | | stable | stable | | stable | | | | | |
| Stability | Stable | Stable | Not | Not | Not | Not | Stable | Not | Stable | Stable | Stable |
| (column) | | | stable | stable | Measured | stable | | Measured | | | |
| Lambda (w/k · m - TC | 0.043 | 0.044 | — | — | Not | — | Not | Not | Not | 0.041 | Not |
| meter measurement) | | | | | Measured | | Measured | Measured | Measured | | Measured |

Not stable means that the foam collapsed.

TABLE (IV)
Analyses of mineral foams with different foaming agents

| | Aqueous foam formula | | | | | | | | | |
|---|---|---|---|---|---|---|---|---|---|---|
| | 2 | 2 | 3 | 3 | 4 | 4 | 5 | 5 | 6 | 6 |
| Slurry formula | II | VI | II | VI | II | VI | II | VI | II | VI |
| Wet density of foamed slurry | 112 | 118 | 105 | 109 | 104 | 112 | 117 | 111 | 106 | 109 |
| (g/l) | | | | | | | | | | |
| Dry density (g/l) | 73 | — | 69 | — | 68 | — | 76 | — | 69 | — |
| Stability (cube) | Stable | Not | Stable | Not | Stable | Not | Stable | Not | Stable | Not |
| | | Stable | | stable | | stable | | stable | | stable |
| Stability | Stable | Not | Stable | Not | Stable | Not | Stable | Not | Stable | Not |
| (column) | | Stable | | stable | | stable | | stable | | stable |
| Lambda (w/k · m - TC meter | 0.043 | — | 0.042 | — | 0.043 | — | Not | — | 0.043 | — |
| measurement) | | | | | | | Measured | | | |

Not stable means that the foam collapsed.

### II.5 Conclusions

These examples allow assessment of the role played by the soluble alkali equivalent in the stability of a cement foam. If the alkalinity content is held at a low level through the use of a low alkali cement, or if the ratio x/(W/C) is lower than 1.75, the foam is stable. When the alkali content increases, the foam becomes destabilised and collapses. It can be noted that the type of clinker used does not have any influence on the stability of the foam. For example, the clinker contained in the cement of slurry formula III (comparative) and V (of the invention) have the same origin. However, the soluble alkali equivalent of the cement used in formula V is strongly reduced through the addition of slag. This dilution allows obtaining of the desired stability.

The invention is not limited to the embodiments presented and other embodiments will be clearly apparent to persons skilled in the art.

1. A Method for producing a mineral foam comprising the following steps:
(i) independently preparing a cement slurry and an aqueous foam, the cement slurry being prepared by mixing water W and cement C, the cement C comprising an amount x of soluble Na₂O equivalent, x being expressed in weight per 100 parts of cement, said slurry having a ratio x/(W/C) less than or equal to 1.75, with W/C expressed by weight, and the particles of cement C have a particle size distribution such that the ratio d_{max(h/2)}/d_{min(h/2)} of the particle size distribution is between 5 and 25;
(ii) contacting the cement slurry with the aqueous foam to obtain a slurry of foamed cement; and
(iii) forming the slurry of foamed cement obtained at step (ii) and leaving to set.

2. The method according to claim 1, wherein the ratio x/(W/C) is less than or equal to 1.60.

3. The method according to claim 1, wherein the ratio d_{max(h/2)}/d_{min(h/2)} is from 6 to 14.

4. The method according to claim 1, wherein the cement is a cement of type CEM I, CEM II, CEM III, CEM IV or CEM V.

5. The method according to claim 1, wherein the cement has a Blaine specific surface area of 3 500 to 10 000 cm²/g.

6. The method according to claim 1, wherein the cement slurry comprises a water reducing agent of plasticizer or superplasticizer type.

7. The method according to claim 1, wherein the mineral foam comprises a mineral addition.

8. The method according to claim 1, wherein the mineral foam contains substantially no fine particles.

9. The method according to claim 1, wherein the W/C weight ratio of the cement slurry ranges from 0.23 to 2.0.

10. The method according to claim 1, wherein the aqueous foam comprises water and a foaming agent.

11. A mineral foam obtainable using the method according to claim 1.

12. The foam according to claim 11, having a dry density of 30 to 300 kg/m³.

13. The foam according to claim 11, having a thermal conductivity of 0.030 to 0.150 W/(m·K).

14. A construction element comprising a mineral foam according to claim 11.

15. A method comprising utilizing the mineral foam according to claim 11 as insulating material.

16. The method according to claim 2, wherein the ratio x/(W/C) is less than or equal to 1.50.

17. The method according to claim 15, wherein the mineral foam is utilized as thermal or sound insulation.
